(19) United States
(12) Patent Application Publication
(10) Pub. No.: US 2026/0161494 A1
(43) Pub. Date: Jun. 11, 2026

(54) Data Interaction and Communication in Multiple Chips

(71) Applicant: Anker Innovations Technology Co., Ltd., Changsha (CN)

(72) Inventors: Yefu Wu, Shenzhen (CN); Feiyue HONG, Shenzhen (CN)

(21) Appl. No.: 19/326,279

(22) Filed: Sep. 11, 2025

(30) Foreign Application Priority Data
Sep. 26, 2024 (CN) 202411354010.5

(51) Int. Cl. G06F 11/07; G06F 12/02; G06F 13/16

(52) U.S. Cl. CPC G06F 11/0745; G06F 11/0793; G06F 12/0223; G06F 13/1668; G06F 2212/1024

(57) ABSTRACT

The present application relates to data interaction and communication in multiple chips. A method comprises obtaining, by a main control chip, address information of random access memory (RAM) areas of a peripheral processing chip. The main control chip communicates with the peripheral processing chip via a serial communication protocol. The address information is included in a configuration file for the peripheral processing chip, and the address information is used to store communication data between the peripheral processing chip and the main control chip. The method further comprises sending, by the main control chip, communication protocol data to the peripheral processing chip based on the address information of the RAM areas. The communication protocol data comprises information associated with a read or write operation and an RAM address of one of the RAM areas.

### CROSS-REFERENCE TO RELATED APPLICATION

The present application claims priority to CN Application No. 202411354010.5, filed on Sep. 26, 2025. The above application is hereby incorporated in its entirety.

### TECHNICAL FIELD

The present application relates to the technical field of communication, in particular to a data interaction method, a Bluetooth headset chip, a Bluetooth headset, a data interaction apparatus, an electronic device, a computer-readable storage medium, and a computer program product.

### BACKGROUND

With the development of information technology, an increasing number of products require data exchange between chips. In a dual-chip system, resources of each chip (such as memory and processor performance) are limited. Therefore, resources need to be efficiently allocated and utilized between two chips to improve the performance of the overall system.

When data needs to be moved from one chip to another, conventional approaches usually require DMA (Direct Memory Access) or program-controlled data migration. However, the data migration process consumes a large number of CPU (Central Processing unit) resources and bandwidths and increase latency, which reduces the efficiency of data processing.

### SUMMARY

In view of the above technical problems, it is desirable to provide an efficient data interaction method, a Bluetooth headset chip, a Bluetooth headset, an electronic device, a computer-readable storage medium, and a computer program product.

The present application provides a data interaction method. The method comprises obtaining, by a main control chip, address information of random access memory (RAM) areas of a peripheral processing chip. The main control chip communicates with the peripheral processing chip via a serial communication protocol. The address information is included in a configuration file for the peripheral processing chip, and the address information is used to store communication data between the peripheral processing chip and the main control chip. The method further comprises sending, by the main control chip, communication protocol data to the peripheral processing chip based on the address information of the RAM areas. The communication protocol data comprises information associated with a read or write operation and an RAM address of one of the RAM areas.

In another aspect, the present application further provides a data interaction method. The method comprises receiving, based on a serial communication protocol, by a peripheral processing chip and from a main control chip, a protocol data packet. The main control chip communicates with the peripheral processing chip via a serial communication protocol. The address information is included in a configuration file for the peripheral processing chip, and the address information is used to store communication data between the peripheral processing chip and the main control chip. The method further comprises: storing, based on the protocol data packet, address information of random access memory (RAM) areas of the peripheral processing chip to a communication area; and receiving, from the main control chip, communication protocol data comprising information associated with a read or write operation and an RAM address of one of the RAM areas. The method further comprises performing a read or write operation based on the communication protocol data and the RAM address of one of the RAM areas.

In another aspect, the present application further provides a Bluetooth headset chip, where the Bluetooth headset chip is used to perform the foregoing data interaction method for data interaction with a peripheral processing chip, address information of RAM areas is defined in a configuration file for the peripheral processing chip, and the address information of the RAM areas is used to store communication data between the peripheral processing chip and the main control chip.

In another aspect, the present application further provides a Bluetooth headset, where the Bluetooth headset includes the foregoing Bluetooth headset chip and a peripheral processing chip, the Bluetooth headset chip communicates with the peripheral processing chip via a serial communication protocol, address information of RAM areas is defined in a configuration file for the peripheral processing chip, and the address information of the RAM areas is used to store communication data between the peripheral processing chip and the main control chip.

In another aspect, the present application further provides an electronic device, where the electronic device includes a main control chip and a peripheral processing chip that communicate via a serial communication protocol, the main control chip is used for the foregoing data interaction method for data interaction with the peripheral processing chip, address information of RAM areas is defined in a configuration file for the peripheral processing chip, and the address information of the RAM areas is used to store communication data between the peripheral processing chip and the main control chip.

In another aspect, the present application further provides a non-transitory computer-readable storage medium, having a computer program stored therein, the computer program, when executed by a main control chip, implementing the steps of the data interaction method in any of the above.

In another aspect, the present application further provides a computer program product, including a computer program, the computer program, when executed by a main control chip, implementing the steps of the data interaction method in any of the above.

According to the data interaction method, the Bluetooth headset chip, the Bluetooth headset, the electronic device, the computer-readable storage medium, and the computer program product, the main control chip communicates with the peripheral processing chip via the serial communication protocol, and by pre-defining, in the configuration file for the peripheral processing chip, the address information of the RAM areas used to store communication data between the peripheral processing chip and the main control chip, when the main control chip needs data interaction with the peripheral processing chip, the main control chip sends communication protocol data carrying a read-write flag bit and an RAM address to the peripheral processing chip based on the address information of the RAM area. This method enables the peripheral processing chip to directly perform a corresponding data read-write operation based on the read-write flag bit and the RAM address, to achieve data interaction between the main control chip and the peripheral processing chip, without the scheduling and intervention of a CPU or DMA controller, thereby simplifying the communication process, reducing unnecessary data processing operations, shortening data processing time, and effectively improving data processing efficiency.

### BRIEF DESCRIPTION OF THE DRAWINGS

In order to illustrate technical solutions in the present application or the related art more clearly, the accompanying drawings required in the description of the examples of the present application or the related art will be briefly introduced below. The drawings described below show merely some examples of the present application. A person of ordinary skill in the art may also derive other related drawings based on these drawings without any creative efforts.

FIG. 1 is an application environment diagram of a data interaction method in one example;

FIG. 2 is a schematic flowchart of a data interaction method in one example;

FIG. 3 is a schematic flowchart of a data interaction method in another example;

FIG. 4 is a schematic flowchart of a data interaction method in yet another example;

FIG. 5 is a detailed flowchart of a data interaction method in one example;

FIG. 6 is a structural block diagram of a data interaction apparatus in an example;

FIG. 7 is a structural block diagram of a data interaction apparatus in another example; and

FIG. 8 is an internal structure diagram of a computer device in one example.

### DETAILED DESCRIPTION

In order to make the objectives, technical solutions, and advantages of the present application clearer, the following further describes the present application in detail in conjunction with the accompanying drawings and examples. It should be understood that the specific examples described herein are merely used to explain the present application, but not to limit the present application.

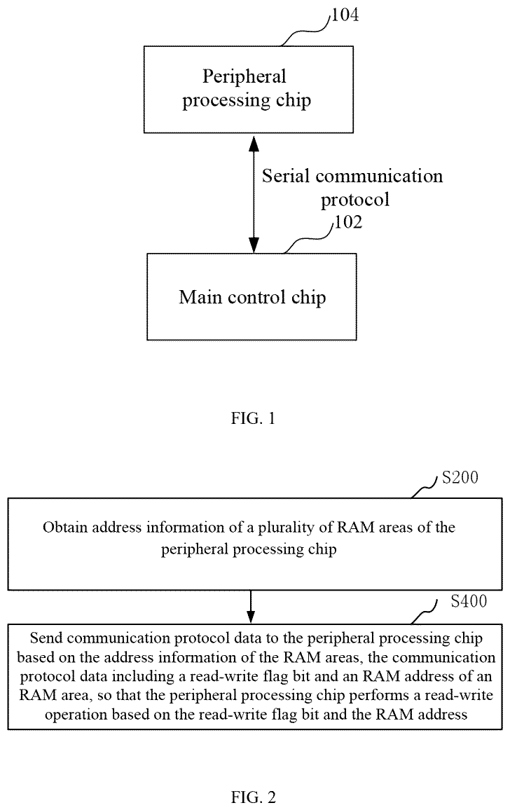

A data interaction (e.g., data communication) method provided by the present application may be applied to an environment as shown in FIG. 1. A main control chip 102 (e.g., a first chip) can communicate with a peripheral processing chip 104 (e.g., second chip) via a serial communication protocol. Address information of random access memory (RAM) areas may be defined in a configuration file for the peripheral processing chip 104, and the address information of RAM areas may be used to store communication data between the peripheral processing chip 104 and the main control chip 102. There may be one or more RAM area. An RAM area may comprise a reserved portion of RAM that is used as a buffer or workspace for transferring, storing, or processing data.

Specifically, when the main control chip 102 needs data interaction with the peripheral processing chip 104, the main control chip 102 may pull a chip select pin low to select the peripheral processing chip 104 for communication, and the two chips make their first handshake. The main control chip 102 may send data to the peripheral processing chip 104 via an MOSI (Master Out Slave In) pin, to obtain address information of a plurality of RAM areas of the peripheral processing chip 104. Subsequently, when data needs to be written or read in the peripheral processing chip 104, a corresponding RAM area can be selected based on actual application requirements. A specific RAM address may be determined based on the address information of the RAM area. Communication protocol data may be sent to the peripheral processing chip 104, and may include a read-write flag bit and the RAM address, so that the peripheral processing chip 104 performs a read-write operation based on the read-write flag bit and the RAM address, thereby achieving data interaction between the main control chip 102 and the peripheral processing chip 104.

The main control chip 102 may include, but is not limited to, Bluetooth headset chips, audio chips, and main control chips of other products. For example, the main control chip 102 may provide core audio processing functions, such as receiving and decoding audio data streams, much like a CPU in a computer. The peripheral processing chip may include, but is not limited to, audio data processing chips, image data processing chips, and other functional chips. For example, a peripheral processing chip may include components dedicated to specific audio tasks, such as active noise cancellation.

In an example, as shown in FIG. 2, a data interaction method is provided. For example, the method can be applied to the main control chip 102 in FIG. 1. The main control chip 102 may communicate with the peripheral processing chip 104 via an SPI communication protocol. The method comprises steps S200 to S400 below.

S200. A main chip may obtain address information of a plurality of RAM areas of a peripheral processing chip.

The main control chip may comprise a chip that integrates core processing functions. The peripheral processing chip may comprise other chips in a product except the main control chip, and these chips are often used to expand functions or assist the main control chip in completing specific tasks. Taking a Bluetooth headset as an example, the main control chip in the Bluetooth headset may be a Bluetooth headset chip, which integrates a Bluetooth radio function and other core processing functions, and is used to establish Bluetooth connections, process audio signals, and control operations on the headset (such as play/pause music and answer a call). The peripheral processing chip in the Bluetooth headset may comprise other chips in the Bluetooth headset except the Bluetooth headset chip, including dedicated chips used for audio processing, sensor data processing, storage, and the like.

In practical applications, the serial communication protocol includes, but is not limited to, SPI (Serial Peripheral Interface), I²C (Inter-Integrated Circuit), and UART (Universal Asynchronous Receiver/Transmitter) protocols. SPI is a serial peripheral interface and a high-speed, full-duplex communication serial bus interface, with the advantages of simple communication, high data transmission rate, and the like. In an example, the main control chip is connected to the peripheral processing chip via the SPI. It should be noted that, due to the influence of practical application requirements, hardware limitations, costs, and complexity, data transmission and data reception do not need to be simultaneous, and a half-duplex communication mode can meet such a requirement. Therefore, in this example, the main control chip and the peripheral processing chip may employ the half-duplex communication mode, that is, the SPI is configured for half-duplex communication. Data transmission and data reception are not simultaneous but alternate. Specifically, the SPI employs a master-slave communication mode, the main control chip provides clock signals for SPI communication and is an active party of communication, while the peripheral processing chip is a passive party in the SPI communication process, and the transmission and reception are controlled by the main control chip. The main control chip may be mounted with one slave, namely, the peripheral processing chip, or mounted with a plurality of peripheral processing chips, and provide chip select signals for each peripheral processing chip. There may be one or more RAM area. The address information of an RAM area includes a starting address and an address range of the RAM area. For example, the address range of one RAM area may be from 0×2000 to 0×20FF, where 0×2000 is the starting address. In addition to the SPI, the main control chip may communicate with the peripheral processing chip via other types of interfaces, such as an SDIO (Serial Peripheral Interface), an I²C interface, and a PCM (Pulse Code Modulation) interface.

In an example, the main control chip is a Bluetooth headset chip. In practical applications, a fixed RAM area of the peripheral processing chip may be pre-designed by a developer, and the RAM area of the peripheral processing chip may be divided into a plurality of areas according to actual service requirements, for example, the RAM area may be divided into a communication area, a system info (system information) area, an audio data area, a call area, and the like.

The communication area (readable and writable) may be mainly used to receive instruction data transmitted by the main control chip and parse and reply the instruction data.

The system info area (unreadable and unwritable) may be used to store system-related information, including software version numbers, hardware version numbers, selective noise reduction in addresses, selective noise reduction out addresses, spatial audio in addresses, and spatial audio out addresses.

The audio data area may be divided into various audio data sub-areas that require data processing in the peripheral processing chip, where an in sub-area can only be used for write, and an out sub-area can only be used for read.

Subsequently, the developer specifies a starting address and an address range for each divided RAM area in a ram_sysbus.ld file (configuration file) of the peripheral processing chip, that is, specifies a starting address and an address range of each RAM area and how to configure a system bus, where the starting address and the address range are used to store communication data between the main control chip and the peripheral processing chip. When the address of the RAM area is used, a linker stores data in a data segment following this address, thereby achieving the effect of storing data in a fixed area. Then, based on a communication data volume, this address is cited in a program and assigned a specific size.

During specific implementation, in an example, the main control chip and the peripheral processing chip may be activated, the main control chip pulls down its chip select pin to communicate with the peripheral processing chip, then the main control chip and the peripheral processing chip make their first handshake. The main control chip sends communication data to the peripheral processing chip. The peripheral processing chip parses the communication data and feeds the parsed data and the address information of each RAM area back to the main control chip. The main control chip obtains the address information of the plurality of RAM areas of the peripheral processing chip.

S400. The main control chip may send communication protocol data to the peripheral processing chip based on the address information of the RAM areas, the communication protocol data including information associated with a read-write operation (e.g., a read-write flag bit) and an RAM address of an RAM area, so that the peripheral processing chip performs a read-write operation based on the read-write flag bit and the RAM address.

The read-write flag bit is a bit flag and may include a read flag bit and a write flag bit. The read flag bit is used to indicate read operation communication, and the write flag bit is used to indicate write operation communication.

After the main control chip obtains the address information of the RAM areas of the peripheral processing chip, the address information of the RAM areas may be saved. Subsequently, an RAM area where data is to be written or read is determined based on a specific service scenario, then the address information of the RAM area is obtained. An RAM address may be randomly determined based on the address information, and communication protocol data may be sent to the peripheral processing chip based on the RAM address, where the communication protocol data includes a read-write flag bit and the RAM address. Upon receiving the communication protocol data, the peripheral processing chip parses the communication protocol data and performs a read-write operation based on the read-write flag bit. For example, if a write flag bit is parsed out, data to be processed is written to a data segment following the RAM address. If a read flag bit is parsed out, data at the RAM address is read out and transmitted to the main control chip. In this way, data interaction between the main control chip and the peripheral processing chip is performed.

In the foregoing data interaction method, the main control chip communicates with the peripheral processing chip via the serial communication protocol, and by pre-defining, in the configuration file for the peripheral processing chip, the address information of the RAM areas used to store communication data between the peripheral processing chip and the main control chip, when the main control chip needs data interaction with the peripheral processing chip, the main control chip sends communication protocol data carrying a read-write flag bit and the RAM address to the peripheral processing chip based on the address information of the RAM area. This method enables the peripheral processing chip to directly perform a corresponding data read-write operation based on the read-write flag bit and the RAM address, to achieve data interaction between the main control chip and the peripheral processing chip, without the scheduling and intervention of a CPU or DMA controller, thereby simplifying the communication process, reducing unnecessary data processing operations, shortening data processing time, and effectively improving data processing efficiency.

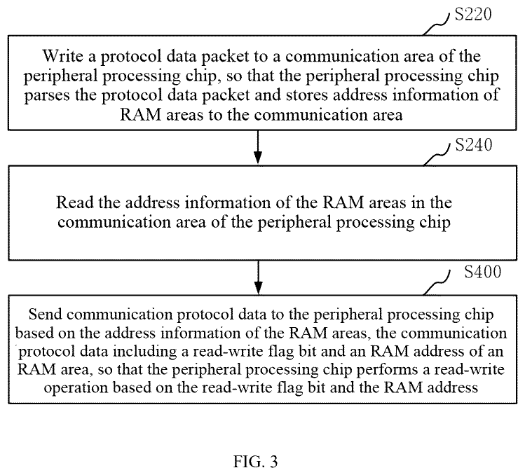

In practical applications, the main control chip may obtain the address information of the RAM area of the peripheral processing chip by sending command data. As shown in FIG. 3, in an example, S200 comprises:

S220. The main control chip may write a protocol data packet to a communication area of the peripheral processing chip, so that the peripheral processing chip parses the protocol data packet and stores address information of RAM areas to the communication area.

S240. The main control chip may read the address information of the RAM areas in the communication area of the peripheral processing chip.

In this example, the protocol data packet is generated by the main control chip based on the serial communication protocol and may include a communication protocol header, a command, a data length, and the like. The communication protocol header may include a read-write flag bit, a data address, and a data buffer bit. The data address refers to a specific RAM address for write or read. The data buffer bit is used to indicate a length of data to be written or read.

During specific implementation, the main control chip may select to pull down an SS signal line to establish a first handshake with the peripheral processing chip. During the first handshake, the main control chip needs to obtain system information of the peripheral processing chip, such as a software version number, a hardware version number, and the address information of the RAM area, so as to directly perform a read-write operation on the RAM of the peripheral processing chip subsequently. Specifically, the main control chip may generate a protocol data packet based on the serial communication protocol, where the data packet may include a command code, address information, data length, data content, and the like. Subsequently, the main control chip writes the protocol data packet into the communication area of the peripheral processing chip via an MOSI signal line. Upon receiving the protocol data packet, the peripheral processing chip parses the protocol data packet. After parsing data, the peripheral processing chip verifies the integrity and correctness of the data and then stores system information (including address information of each RAM area) to the communication area. The main control chip reads the system information from the communication area of the peripheral processing chip, including reading the address information of the plurality of RAM areas. It is understandable that the main control chip only needs to obtain the address information of each RAM area of the peripheral processing chip once. After the main control chip obtains the address information of each RAM area of the peripheral processing chip, the main control chip may save the address information. In the subsequent data interaction process, the main control chip may directly perform a read-write operation on the peripheral processing chip based on the address information of each RAM area.

In this example, by directly writing the protocol data packet into the communication area of the peripheral processing chip to instruct the peripheral processing chip to feed back the address information of the plurality of RAM areas, the data interaction process is simplified, and complex intermediate layers and software stacks are not required. By reading the address information of the RAM area, the address information of the RAM area of the peripheral processing chip can be quickly and accurately obtained.

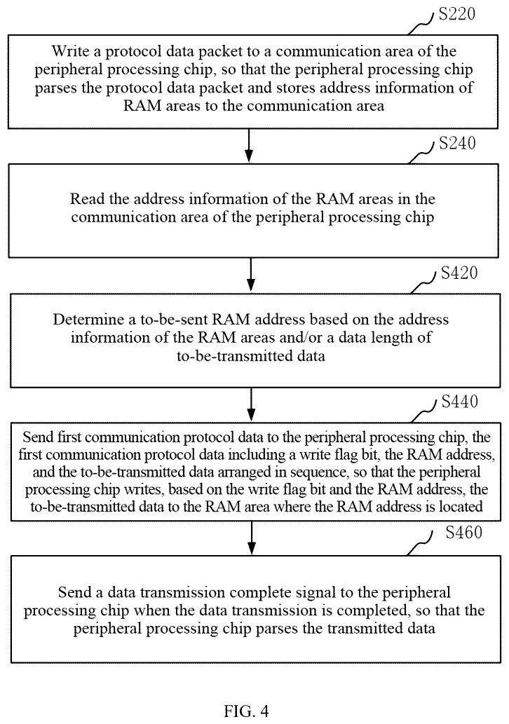

In practical applications, there are various ways of data interaction between the main control chip and the peripheral processing chip, including data transmission and data reading. As shown in FIG. 4, taking a data transmission scenario as an example, S400 comprises:
S420. The main control chip may determine a to-be-sent RAM address based on the address information of the RAM areas and/or a data length of to-be-transmitted data.

S440. The main control chip may send first communication protocol data to the peripheral processing chip, the first communication protocol data including a write flag bit, the RAM address, and the to-be-transmitted data arranged in sequence, so that the peripheral processing chip writes, based on the write flag bit and the RAM address, the to-be-transmitted data to the RAM area where the RAM address is located.

S460. The main control chip may send a data transmission complete signal to the peripheral processing chip when the data transmission is completed, so that the peripheral processing chip parses the transmitted data.

This example is described based on data transmission from the main control chip to the peripheral processing chip (e.g., write data to the peripheral processing chip). Specifically, different types of data need to be transmitted to different RAM areas of the peripheral processing chip. Therefore, the main control chip may select, based on a type of to-be-transmitted data, a storage address range of the type of to-be-transmitted data from the plurality of RAM areas of the peripheral processing chip. For example, if the to-be-transmitted data is audio data, the audio data needs to be written into an audio data area. For example, each data read-write operation involves write or read of all standardized data. In this case, the main control chip may select the address information of the audio data area, and randomly determine a to-be-sent RAM address (e.g., an RAM address to be added to the communication protocol data) from the address range of the audio data area based on the starting address and address range of the audio data area. Then, the main control chip sends first communication protocol data to the peripheral processing chip based on the determined RAM address, where a first byte of the first communication protocol data starts with a write flag bit, followed by the RAM address and the to-be-transmitted data. Upon receiving the first communication protocol data, the peripheral processing chip writes, based on the write flag bit and the RAM address, the to-be-transmitted data to the RAM area where the RAM address is located.

In some examples, if the data read-write operation involves partial write or partial read, the main control chip may consider the starting address and address range of the RAM area and the data length of the to-be-transmitted data to determine a specific RAM address, so that the to-be-transmitted data can be completely written to the RAM area of the peripheral processing chip. Then, the main control chip sends first communication protocol data to the peripheral processing chip based on the determined RAM address, where a first byte of the first communication protocol data starts with a write flag bit, followed by the RAM address and the to-be-transmitted data. Upon receiving the first communication protocol data, the peripheral processing chip writes, based on the write flag bit and the RAM address, the to-be-transmitted data to the RAM area where the RAM address is located.

It is understandable that, in the data transmission process, the main control chip may send clock pulses and to-be-transmitted data through an MOSI pin, where these clock pulses are used to synchronize data transmission. If multi-byte data needs to be written, the main control chip may continuously send clock pulses and to-be-transmitted data until all data are written to a corresponding RAM area of the peripheral processing chip.

Since the main control chip and the peripheral processing chip may employ half-duplex communication, after the data transmission is completed, the main control chip may need to send the data transmission complete signal to the peripheral processing chip, to notify the peripheral processing chip to parse the transmitted data. Upon receiving the data transmission signal, the peripheral processing chip directly starts to parse the data in this RAM area and stores the parsed data to another RAM area. In an example, the main control chip sends the data transmission complete signal to the peripheral processing chip by setting the status of a GPIO (General-Purpose Input/Output) pin to a high level. When the GPIO pin is detected to be at the high level, the peripheral processing chip determines that the data transmission has been completed.

In an example, by setting the status of the GPIO pin, signals are sent to the peripheral processing chip simply and quickly, with high reliability.

In some other examples, the main control chip may send instruction data to the communication area among the RAM areas of the peripheral processing chip via the MOSI pin. When the peripheral processing chip receives the instruction data, it indicates that the data transmission has been completed, and a data parsing operation may begin. In addition, the instruction data may include a specific flag bit to indicate that the data transmission has been completed.

In this example, the instruction data is sent to the communication area of the peripheral processing chip to notify the peripheral processing chip that the data transmission has been completed. Such operation is flexible, controllable, and highly scalable.

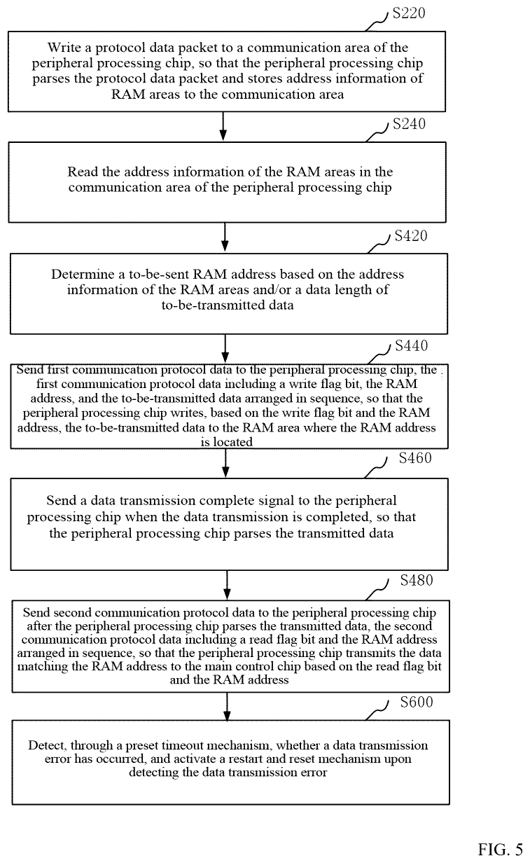

As shown in FIG. 5, in an example, the method further comprises: S480. The main control chip may send second communication protocol data to the peripheral processing chip after the peripheral processing chip parses the transmitted data. The second communication protocol data may include a read flag bit and the RAM address arranged in sequence, so that the peripheral processing chip transmits the data matching the RAM address to the main control chip based on the read flag bit and the RAM address.

In practical applications, the main control chip writes the to-be-transmitted data into the peripheral processing chip for parsing, and the data parsed by the peripheral processing chip needs to be further read, so as to further process the parsed data and achieve a corresponding function.

Following the previous example, after the peripheral processing chip parses the data transmitted by the main control chip, the main control chip may start to read the parsed data. Specifically, the main control chip may periodically and actively read the data parsed by the peripheral processing chip, or send the to-be-transmitted data to the peripheral processing chip and wait for a period of time before reading the data parsed by the peripheral processing chip. A data reading process may be as follows: The main control chip pulls down its chip select pin and sends the second communication protocol data to the peripheral processing chip via its MOSI pin. A first byte of the second communication protocol data starts with the read flag bit, followed by the RAM address and a data buffer bit determined in the data transmission process mentioned above, and may further include other data. After receiving the second communication protocol data, the peripheral processing chip starts to parse the second communication protocol data to determine that the main control chip needs to read data, and transmits the data matching the RAM address to the main control chip. If multi-byte data needs to be read, after the data buffer bit, the main control chip continuously sends a multi-byte clock, and the peripheral processing chip reads out corresponding data in sequence and transmits the read data to the main control chip.

In this example, by directly sending communication protocol data to the peripheral processing chip, the data in the peripheral processing chip can be directly read out, thereby greatly improving data reading speed and reducing communication time.

As shown in FIG. 5, in an example, the method may further comprise: S600. the main control chip may detect, through a preset timeout mechanism, whether a data transmission error has occurred, and activate a restart and reset mechanism upon detecting the data transmission error.

In practical applications, based on expected data transmission time and system performance, a reasonable timeout mechanism may be defined and a timeout threshold may be set. For example, the expected data transmission time may be 100 ms (milliseconds), and the timeout threshold may be set to 200 ms. A timer is started at the beginning of data transmission. The timer starts timing at the beginning of data transmission and triggers a timeout event when the preset timeout threshold arrives. The status of data transmission is monitored in the data transmission process. If the data transmission is completed within the expected time, the timer is reset or stopped. If the timer reaches the preset timeout threshold but the data transmission is still not completed, the data transmission error may have occurred and the timer triggers the timeout event. Upon detecting the timeout threshold, the main control chip activates the restart and reset mechanism. Specifically, the restart and reset mechanism includes resetting the main control chip, or resetting the SPI, or resending to-be-transmitted data, or performing other fault recovery steps, or the like.

In some other examples, the main control chip may add a cyclic redundancy check (CRC) value to the end of a protocol data packet before sending the protocol data packet to the peripheral processing chip. Upon receiving the protocol data packet, the peripheral processing chip recalculates the CRC value, and compares the calculated CRC value with the received CRC value; if the calculated CRC value matches the received CRC value, the peripheral processing chip receives and parses the data packet; and if the calculated CRC value does not match the received CRC value, the data packet is considered damaged or incorrect, and the peripheral processing chip may send a data retransmission signal to the main control chip to request retransmission of data.

In this example, the data transmission error can be detected in a timely manner through the timeout mechanism, and the corresponding restart and reset mechanism can be activated, thereby reducing unnecessary waiting time and the risk of data loss, and improving the stability and reliability of the system.

In one example, the present application provides a data interaction method. For example, the method is applied to a peripheral processing chip. The method comprises the following steps:

S800. The peripheral processing chip may receive a protocol data packet sent by a main control chip, the protocol data packet being generated based on a serial communication protocol.

S820. The peripheral processing chip may parse the protocol data packet, and store address information of RAM areas to a communication area, so that the main control chip reads the address information of the plurality of RAM areas in the communication area.

S840. Upon receiving communication protocol data sent by the main control chip, the peripheral processing chip may perform a read-write operation based on a read-write flag bit and an RAM address of an RAM area in the communication protocol data.

During specific implementation, the main control chip may generate a protocol data packet based on the serial communication protocol (such as an SP protocol), where the data packet usually includes information such as command code, a read-write flag bit, address information, a data length, and data content. And the main control chip may write the generated data packet into the communication area of the peripheral processing chip via a serial communication interface.

Upon receiving the protocol data packet, the peripheral processing chip may parse the data packet to extract key information such as command code and data content. Subsequently, after verification of the integrity and correctness of the data, the peripheral processing chip may store system information (e.g., address information of each RAM area) to the communication area.

The main control chip may read the system information from the communication area of the peripheral processing chip, including reading the address information of the plurality of RAM areas. Subsequently, the main control chip can directly read data from or write data to the peripheral processing chip based on the address information of the plurality of RAM areas in the communication area of the peripheral processing chip.

In the subsequent interaction process, taking the transmission of data from the main control chip to the peripheral processing chip as an example, the main control chip may determine a specific RAM address by considering the starting address and address range of an RAM area of the peripheral processing chip and the data length of to-be-transmitted data, so that the to-be-transmitted data can be completely written into the RAM area of the peripheral processing chip. Then, the main control chip may transmit first communication protocol data to the peripheral processing chip based on the determined RAM address, where a first byte of the first communication protocol data starts with a write flag bit, followed by the RAM address and the to-be-transmitted data. After the data transmission is completed, the main control chip may set the status of its GPIO pin to a high level, to send a data transmission complete signal to the peripheral processing chip.

Upon detecting the GPIO pin at the high level, the peripheral processing chip may determine that the data transmission has been completed, directly start to parse the data in the RAM area, and store the parsed data to another RAM.

After receiving the first communication protocol data, the peripheral processing chip may write, based on the write flag bit and the RAM address, the to-be-transmitted data to the RAM area where the RAM address is located.

After the peripheral processing chip parses the data transmitted by the main control chip and writes the data into the corresponding RAM area, the main control chip may start to read the parsed data. For example, the main control chip may periodically and actively read the data parsed by the peripheral processing chip, or send the to-be-transmitted data to the peripheral processing chip and wait for a period of time before reading the data parsed by the peripheral processing chip.

A data reading process may be as follows: The main control chip pulls down its chip select pin and sends the second communication protocol data to the peripheral processing chip via its MOSI pin. A first byte of the second communication protocol data starts with the read flag bit, followed by the RAM address and a data buffer bit determined in the data transmission process mentioned above, and may further include other data. After receiving the second communication protocol data, the peripheral processing chip starts to parse the second communication protocol data to determine that the main control chip needs to read data, and transmits the data matching the RAM address to the main control chip. If multi-byte data needs to be read, after the data buffer bit, the main control chip continuously sends a multi-byte clock, and the peripheral processing chip reads out corresponding data in sequence and transmits the read data to the main control chip.

To provide a clearer explanation of the data interaction method provided in the present application, the following describes a specific example. In the example, a main control chip communicates with a peripheral processing chip via an SPI communication protocol as an example for illustration. The specific example comprises the following steps:

S100. The main control chip writes a protocol data packet to a communication area of the peripheral processing chip, so that the peripheral processing chip parses the protocol data packet and stores address information of a plurality of RAM areas to the communication area.

S102. The main control chip reads the address information of the plurality of RAM areas in the communication area of the peripheral processing chip.

S104. The main control chip may determine a to-be-sent RAM address based on the address information of the RAM areas and/or a data length of to-be-transmitted data.

S106. The main control chip may send first communication protocol data to the peripheral processing chip based on the to-be-sent RAM address. The first communication protocol data may include a write flag bit, the RAM address, and the to-be-transmitted data arranged in sequence, so that the peripheral processing chip writes, based on the write flag bit and the RAM address, the to-be-transmitted data to the RAM area where the RAM address is located.

In the data transmission process, the main control chip may detect, through a preset timeout mechanism, whether a data transmission error has occurred, and activate a restart and reset mechanism upon detecting the data transmission error.

S108. When the data transmission is completed, the main control chip may set its GPIO pin to a high-level status and send a data transmission complete signal to the peripheral processing chip, so that the peripheral processing chip parses the transmitted data.

S110. After the peripheral processing chip parses the transmitted data, the main control chip may send second communication protocol data to the peripheral processing chip. The second communication protocol data may include a read flag bit and the RAM address arranged in sequence, so that the peripheral processing chip transmits the data matching the RAM address to the main control chip based on the read flag bit and the RAM address.

It should be understood that, although the steps in the flowcharts of the examples as described above are displayed sequentially according to the instructions of arrows, these steps are not necessarily performed sequentially according to the sequence instructed by the arrows. Unless otherwise explicitly specified herein, the steps are not limited in a strict sequence, but may be performed in other sequences. Moreover, at least some of the steps in the flowchart of each example may include a plurality of steps or a plurality of stages. These steps or stages are not necessarily performed at the same time, but may be performed at different time. The steps or stages are not necessarily sequentially performed, but may be performed alternately with other steps or at least some of steps or stages of other steps.

Based on the same inventive concept, an example of the present application further provides a data interaction apparatus for implementing the data interaction method described above. The implementation scheme provided by the apparatus to solve the problems is similar to the implementation scheme described in the foregoing method. Therefore, the specific limitations in one or more data interaction apparatus examples provided below may be referred to the limitations on the data interaction method above, and will not be elaborated here.

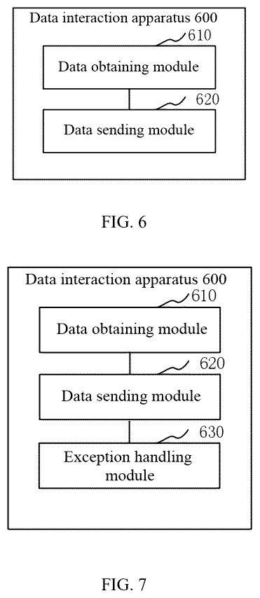

In an example, as shown in FIG. 6, a data interaction apparatus 600 is provided. The data interaction apparatus 600 may include a main control chip (e.g., the main control chip 102). The main control chip communicates with a peripheral processing chip (e.g., the peripheral processing chip 104) via a serial communication protocol. Address information of RAM areas is defined in a configuration file for the peripheral processing chip, the address information of the RAM areas is used to store communication data between the peripheral processing chip and the main control chip, and the apparatus includes a data obtaining module 610 and a data sending module 620.

The data obtaining module 610 may be configured to obtain address information of a plurality of RAM areas of the peripheral processing chip. The data sending module 620 may be configured to send communication protocol data to the peripheral processing chip based on the address information of the RAM areas. The communication protocol data may include a read-write flag bit and an RAM address of an RAM area, so that the peripheral processing chip performs a read-write operation based on the read-write flag bit and the RAM address.

In an example, the data obtaining module 610 may be further configured to write a protocol data packet to a communication area of the peripheral processing chip, so that the peripheral processing chip parses the protocol data packet and stores the address information of the RAM areas to the communication area; and read the address information of the plurality of RAM areas in the communication area of the peripheral processing chip. The protocol data packet is generated based on the serial communication protocol.

In an example, the data sending module 620 may be further configured to determine a to-be-sent RAM address based on the address information of the RAM areas and/or a data length of to-be-transmitted data, and send first communication protocol data to the peripheral processing chip. The first communication protocol data may include a write flag bit, the RAM address, and the to-be-transmitted data arranged in sequence, so that the peripheral processing chip writes, based on the write flag bit and the RAM address, the to-be-transmitted data to the RAM area where the RAM address is located; and send a data transmission complete signal to the peripheral processing chip when the data transmission is completed, so that the peripheral processing chip parses the transmitted data.

In an example, the data sending module 620 may be further configured to set the status of a GPIO pin to a high level, or send instruction data to the communication area among the RAM areas of the peripheral processing chip.

In an example, the data sending module 620 may be further configured to send second communication protocol data to the peripheral processing chip after the peripheral processing chip parses the transmitted data. The second communication protocol data may include a read flag bit and the RAM address arranged in sequence, so that the peripheral processing chip transmits the data matching the RAM address to the main control chip based on the read flag bit and the RAM address.

As shown in FIG. 7, in an example, the apparatus further includes an exception handling module 630 (e.g., an error handling module), configured to detect, through a preset timeout mechanism, whether a data transmission error has occurred, and activate a restart and reset mechanism upon detecting the data transmission error.

In one example, a data interaction apparatus 700 may be provided. The data interaction apparatus 700 may include a peripheral processing chip (e.g., the peripheral processing chip 104). The peripheral processing chip communicates with a main control chip (e.g., the main control chip 102) via a serial communication protocol. Address information of RAM areas is defined in a configuration file for the peripheral processing chip, the address information of the RAM areas is used to store communication data between the peripheral processing chip and the main control chip, and the apparatus includes a data receiving module 710, a data parsing module 720, and a data read-write module 730.

The data receiving module 710 may be configured to receive a protocol data packet sent by the main control chip. The protocol data packet may be generated based on the serial communication protocol.

The data parsing module 720 may be configured to parse the protocol data packet, and store address information of RAM areas to a communication area, so that the main control chip reads the address information of the plurality of RAM areas in the communication area.

The data read-write module 730 is configured to, upon receiving communication protocol data sent by the main control chip, perform a read-write operation based on a read-write flag bit and an RAM address of an RAM area in the communication protocol data.

Various modules in the foregoing data interaction apparatus may be fully or partially implemented through software, hardware, and a combination thereof. The modules may be embedded in or independent of the main control chip in a computer device in a hardware form, or stored in a memory of a computer device in a software form, so that the main control chip calls the modules to perform operations corresponding to the modules.

In an example, a Bluetooth headset chip is provided. The Bluetooth headset chip is used to perform the steps of the data interaction method in any of the foregoing examples for data interaction with a peripheral processing chip, where address information of RAM areas is defined in a configuration file for the peripheral processing chip, and the address information of the RAM areas is used to store communication data between the peripheral processing chip and the main control chip.

It is understandable that the Bluetooth headset chip includes but is not limited to modules such as a Bluetooth radio module, a microcontroller unit, an audio processing unit, a microphone preamplifier, and a power management unit. The above content is merely the part related to the solution of the present application, and does not constitute a limitation on the application of the solution of the present application to the Bluetooth headset chip.

The present application further provides a Bluetooth headset. The Bluetooth headset includes the foregoing Bluetooth headset chip and a peripheral processing chip, the Bluetooth headset chip communicates with the peripheral processing chip via a serial communication protocol, address information of RAM areas is defined in a configuration file for the peripheral processing chip, and the address information of the RAM areas is used to store communication data between the peripheral processing chip and the main control chip.

It is understandable that, in addition to the Bluetooth headset chip and the peripheral processing chip, the Bluetooth headset further includes, but is not limited to, a speaker, a microphone, a battery, a charging interface, a touch panel or physical buttons, and the like. The above content is merely the part related to the solution of the present application, and does not constitute a limitation on the application of the solution of the present application to the Bluetooth headset.

The present application further provides an electronic device. The electronic device includes a main control chip and a peripheral processing chip that communicate via a serial communication protocol, the main control chip is used for data interaction with the peripheral processing chip through the steps of the data interaction method in any of the foregoing examples, address information of RAM areas is defined in a configuration file for the peripheral processing chip, and the address information of the RAM areas is used to store communication data between the peripheral processing chip and the main control chip.

It is understandable that the electronic device includes, but is not limited to, a headphone, a speaker, a Bluetooth headset, and other electronic devices including multiple chips such as a main control chip and a peripheral processing chip that communicate serially.

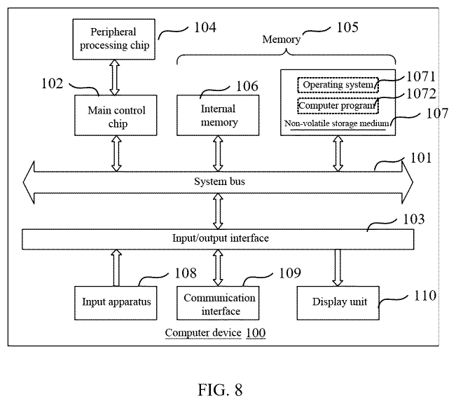

For example, as shown in FIG. 8, an electronic device 100 may include the main control chip 102, the peripheral processing chip 104, a memory 105, an input/output interface 103, a communication interface 109, a display unit 110, and an input apparatus 108. The main control chip 102, the memory 105, and the input/output interface 103 are connected through a system bus 101. The communication interface 109, the display unit 110, and the input apparatus 108 are connected to the system bus 101 through the input/output interface 103. The main control chip 102 of the electronic device 100 is used to provide computing and control capabilities. The memory 105 of the electronic device 100 includes a non-transitory and non-volatile storage medium 107 and an internal memory 106. The non-transitory and non-volatile storage medium 107 stores an operating system 1071 and a computer program 1072. The internal memory 106 provides an environment for the operations of the operating system 1071 and the computer program 1072 in the non-transitory and non-volatile storage medium 107. The input/output interface 103 of the electronic device 100 is used to exchange information between the main control chip 102 and an external device. The communication interface 109 of the electronic device 100 is used for wired or wireless communication with an external terminal (not shown). The wireless communication may be implemented through WIFI, a mobile cellular network, near field communication (NFC), or other technologies. The computer program 1072 is executed by the main control chip 102 to implement a data interaction method. The display unit 110 of the electronic device 100 is used to form visually visible images, and may be a display, a projection apparatus, or a virtual reality imaging apparatus. The display may be a liquid crystal display or an electronic ink display. The input apparatus 108 of the electronic device may be a touch layer covering the display, or a key, trackball, or touchpad arranged on a shell of the electronic device, or an external keyboard, touchpad, or mouse, or the like.

A person skilled in the art can understand that the structure shown in FIG. 8 is only a block diagram of a partial structure related to the solution of the present application, and does not constitute a limitation on the computer device to which the solution of the present application is applied. The specific computer device may include more or fewer parts than shown in the figure, or combine some parts, or have a different arrangement of parts.

In one example, a computer-readable storage medium is provided, having a computer program stored therein, the computer program, when executed by a main control chip, implementing the steps of the data interaction method in any of the above examples.

In one example, a computer program product is provided, including a computer program, the computer program, when executed by a main control chip, implementing the steps of the data interaction method in any of the above examples.

It should be noted that the data involved in the present application (including but not limited to data used for analysis, storage, display, etc.) are all information and data authorized by users or fully authorized by all parties, and the collection, use, and processing of relevant data should comply with relevant regulations.

A person of ordinary skill in the art can understand that all or some of the processes in the methods of the above examples may be implemented by a computer program instructing related hardware. The computer program may be stored in a non-volatile computer-readable storage medium. The computer program, when executed, may include the processes of the examples of the above methods. Any reference to the memory, database, or other media used in each example provided by the present application may include at least one of a non-volatile memory and a volatile memory. The non-volatile memory may be a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, or the like. The volatile memory may be a random access memory (RAM), an external cache, or the like. As an illustration and not a limitation, the RAM may be in many forms, such as a static random access memory (SRAM) or a dynamic random access memory (DRAM). The database involved in each example provided by the present application may include at least one of a relational database and a non-relational database. The non-relational database may include, but is not limited to, a blockchain-based distributed database and the like, without limitation herein. The main control chip involved in each example provided by the present application may be a processor, and the processor may be a general-purpose processor, a central processing unit, a graphics processing unit, a digital signal processor, a programmable logic processor, a data processing logic processor based on quantum computing, an artificial intelligence (AI) processor, or the like, without limitation herein.

The technical features of the above examples may be combined. To make the description concise, not all possible combinations of the technical features in the above examples are described. However, as long as there is no contradiction in the combinations of these technical features, these combinations should fall within the scope of the present application.

The foregoing examples show only several implementations of the present application and are described in detail, which, however, are not to be construed as a limitation to the patent scope of the present application. It should be noted that a person of ordinary skill in the art can make variations and improvements without departing from the concept of the present application, and these variations and improvements all fall into the scope of protection of the present application. Therefore, the scope of protection of the present application should be subject to the appended claims.

What is claimed is:

1. A data interaction method, comprising:
obtaining, by a main control chip, address information of random access memory (RAM) areas of a peripheral processing chip, wherein the main control chip communicates with the peripheral processing chip via a serial communication protocol, the address information is included in a configuration file for the peripheral processing chip, and the address information is used to store communication data between the peripheral processing chip and the main control chip; and
sending, by the main control chip, communication protocol data to the peripheral processing chip based on the address information of the RAM areas, the communication protocol data comprising information associated with a read or write operation and an RAM address of one of the RAM areas.

2. The data interaction method according to claim 1, wherein:
the RAM areas of the peripheral processing chip comprise a communication area used to receive instruction data sent by the main control chip, and
the obtaining the address information of RAM areas of the peripheral processing chip comprises:
writing a protocol data packet to the communication area of the peripheral processing chip; and
reading the address information of the RAM areas in the communication area of the peripheral processing chip.

3. The data interaction method according to claim 1, wherein the sending the communication protocol data to the peripheral processing chip based on the address information of the RAM areas comprises:
determining a to-be-sent RAM address based on the address information of the RAM areas or a data length of to-be-transmitted data;
sending first communication protocol data to the peripheral processing chip, the first communication protocol data comprising a write flag bit, the RAM address, and the to-be-transmitted data arranged in sequence; and
sending a data transmission complete signal to the peripheral processing chip when data transmission is completed.

4. The data interaction method according to claim 3, wherein the sending the data transmission complete signal to the peripheral processing chip comprises at least one of the following:
setting a status of a general-purpose input/output (GPIO) pin to a high level; or
sending instruction data to a communication area of the peripheral processing chip.

5. The data interaction method according to claim 3, further comprising:
sending second communication protocol data to the peripheral processing chip after the peripheral processing chip parses the transmitted data, the second communication protocol data comprising a read flag bit and the RAM address arranged in sequence.

6. The data interaction method according to claim 1, further comprising:
detecting, through a preset timeout mechanism, whether a data transmission error has occurred; and
activating a restart and reset mechanism upon detecting the data transmission error.

7. A data interaction method, comprising:
receiving, based on a serial communication protocol, by a peripheral processing chip and from a main control chip, a protocol data packet, the protocol data packet, wherein the main control chip communicates with the peripheral processing chip via a serial communication protocol, a configuration file for the peripheral processing chip comprises address information, and the address information is used to store communication data between the peripheral processing chip and the main control chip;
storing, based on the protocol data packet, address information of random access memory (RAM) areas of the peripheral processing chip to a communication area;
receiving, from the main control chip, communication protocol data comprising information associated with a read or write operation and an RAM address of one of the RAM areas; and
performing a read or write operation based on the communication protocol data and the RAM address of one of the RAM areas.

8. The data interaction method according to claim 7, wherein the address information is included in a configuration file for the peripheral processing chip, and the address information is used to store communication data between the peripheral processing chip and the main control chip.

9. The data interaction method according to claim 7, wherein the receiving the communication protocol data comprises:
receiving first communication protocol data comprising a write flag bit, the RAM address, and data arranged in sequence; and
receiving a data transmission complete signal to the peripheral processing chip when data transmission is completed.

10. The data interaction method according to claim 7, further comprising:
receiving instruction data to the communication area of the peripheral processing chip.

11. The data interaction method according to claim 9, further comprising:
receiving second communication protocol data after the peripheral processing chip parses the data, the second communication protocol data comprising a read flag bit and the RAM address arranged in sequence.

12. The data interaction method according to claim 7, further comprising:
parsing data in the protocol data packet and verifying the data.

13. The data interaction method according to claim 7, further comprising:
storing system information of the peripheral processing chip to the communication area, wherein system information comprises a software version number, a hardware version number, and the address information of the RAM areas.

14. The data interaction method according to claim 7, wherein the serial communication protocol comprises one of a serial peripheral interface (SPI) protocol, an inter-integrated circuit (I²C) protocol, or a universal asynchronous receiver/transmitter (UART) protocol.

15. A Bluetooth headset chip comprising a main control chip and a peripheral processing chip, wherein the main control chip is configured to:
obtain address information of random access memory (RAM) areas of the peripheral processing chip, wherein the main control chip communicates with the peripheral processing chip via a serial communication protocol, the address information is included in a configuration file for the peripheral processing chip, and the address information is used to store communication data between the peripheral processing chip and the main control chip; and
send communication protocol data to the peripheral processing chip based on the address information of the RAM areas, the communication protocol data comprising information associated with a read or write operation and an RAM address of one of the RAM areas.

16. The Bluetooth headset chip according to claim 15, wherein:
the RAM areas of the peripheral processing chip comprise a communication area used to receive instruction data sent by the main control chip, and the main control chip is further configured to:
write a protocol data packet to the communication area of the peripheral processing chip; and
read the address information of the RAM areas in the communication area of the peripheral processing chip.

17. The Bluetooth headset chip according to claim 15, wherein the main control chip is further configured to:
determine a to-be-sent RAM address based on the address information of the RAM areas or a data length of to-be-transmitted data;
send first communication protocol data to the peripheral processing chip, the first communication protocol data comprising a write flag bit, the RAM address, and the to-be-transmitted data arranged in sequence; and
send a data transmission complete signal to the peripheral processing chip when data transmission is completed.

18. The Bluetooth headset chip according to claim 17, wherein the main control chip is further configured to:
send second communication protocol data to the peripheral processing chip after the peripheral processing chip parses transmitted data, the second communication protocol data comprising a read flag bit and the RAM address arranged in sequence.

19. The Bluetooth headset chip according to claim 15, wherein the main control chip is further configured to:
detect, through a preset timeout mechanism, whether a data transmission error has occurred; and
activate a restart and reset mechanism upon detecting the data transmission error.

20. The Bluetooth headset chip according to claim 15, wherein the peripheral processing chip is configured to store the address information of the RAM areas of the peripheral processing chip to a communication area.
